(19) United States
(12) Patent Application Publication
(10) Pub. No.: US 2024/0318271 A1
(43) Pub. Date: Sep. 26, 2024

(54) PROCESS FOR THE COMBINED MANUFACTURE OF STEEL AND CEMENT CLINKER

(71) Applicant: CAMBRIDGE ENTERPRISE LIMITED, Cambridge (GB)

(72) Inventors: Cyrille DUNANT, Cambridge (GB); Julian M. ALLWOOD, Cambridge (GB); Philippa HORTON, Cambridge (GB)

(21) Appl. No.: 18/579,112

(22) PCT Filed: Jul. 15, 2022
(86) PCT No.: PCT/EP2022/069912

§ 371 Date: Jan. 12, 2024

(30) Foreign Application Priority Data
Jul. 16, 2021 (GB) 2110292.6

(51) Int. Cl. C21C 5/54; C04B 7/19; C04B 18/06; C21C 5/52

(52) U.S. Cl. CPC C21C 5/54; C04B 7/19; C04B 18/067; C21C 5/527; C21C 2200/00

(57) ABSTRACT

A process is disclosed for the combined manufacture of steel and cement clinker. Steel scrap is loaded in an electric arc furnace for forming molten steel. Cement paste derived from construction and demolition waste is loaded in the electric arc furnace to act as a flux for the steel to assist in the removal of impurities from the molten steel and forming an electric are furnace slag. The heat of the molten steel promotes clinkering of the electric are furnace slag to form clinkered electric arc furnace slag. The clinkered electric arc furnace slag is removed from the electric arc furnace.

### FIELD OF THE INVENTION

The present invention relates to a process for the manufacture of clinker. Such clinker can subsequently be ground to produce cement. One such cement of interest is Portland cement, although other cements can be produced using the present invention.

### BACKGROUND

Concrete is well-known as a construction material. In simple terms, concrete typically consists of a mix of paste and aggregates. Suitable aggregates are coarse and fine particles (sand, gravel, crushed stone, for example). Portland cement is commonly used as the paste. When water is added to Portland cement, hydration reactions occur, leading to the formation of interlocking crystals that provide hydrated Portland cement with strength and hardness.

Typically, Portland cement is manufactured using a cement kiln. The starting materials may be limestone, shale, clay and iron ore. The temperature in the cement kiln (typical temperature 1450-1500° C.) leads to the emission of gases such as CO₂, calcination and clinkerisation. Cement clinker from the kiln takes the form of lumps or nodules of varying sizes. The cement clinker is typically cooled relatively rapidly from the kiln temperature in order to retain the preferred phase composition formed during clinkerisation. The cement clinker is ground to a fine powder and is usually mixed with gypsum (which acts as an early set retarder). The combination forms Portland cement.

Many countries in the world are implementing plans to reduce emissions of greenhouse gases. As an example, the UK is committed to zero emissions by 2050, which with today's technology requires the closure of all cement production plants. Yet building the infrastructure of a zero emissions economy will be impossible without cement. For 30 years, Carbon Capture and Storage (CCS) has been seen as the solution for the remainder of emissions of “hard-to-abate” sectors including cement, yet its deployment has been so tentative that we can now say with confidence that it is very unlikely to be operating at sufficient scale by 2050 to allow anything like today's levels of construction. Therefore there is an urgent need to find alternative means to allow a sufficient level of composite construction to enable a zero emissions economy while itself having zero emissions.

Currently, the production of cement leads to both process and production emissions from the decarbonation of limestone and the burning of fuel. A zero-emissions society will still require a large amount of cement and concrete for the building and maintenance of infrastructure and for the construction of low-carbon power sources [1]. It is therefore important to reduce, and eventually eliminate these emissions, and many options have been put forward to that effect. Most of the proposed strategies to abate emissions focus on the process emissions which result from the decarbonation using substitution materials but fall short of eliminating emissions. Further, many proposed solutions to cement production emissions cannot be deployed at the scale required because they depend on relatively rare materials, or materials with no future supply, such as magnesium cement and alkali-activated binders).

Many of the proposed substitution materials also have the advantage of lower requirements in terms of temperature, but their production processes remain high temperature processes and thus likely difficult to electrify economically. Electrification, biofuels and hydrogen burning are at present the only realistic options to provide both the heat and temperature required, and they all have significant drawbacks: poor scalability, procurement difficulty or very poor efficiency.

A possible solution is the deployment of CCS on adapted current technologies, but this is largely experimental and also unlikely to be available at scale to meet the net zero emissions 2050 target.

Therefore, none of the proposed solutions can provide for zero-carbon concrete in 2050, and their combined deployment potential will fall far short of the objective of no emissions.

A short review of the proposed routes to abate cement production emissions follows.

Replacement of cement by alkali-activated binders. Alkali-activated binders [2, 3, 4], also called “geopolymers” are made from the by-products of primary steel-making and the burning of coal. Accordingly, and to the extent that such activities are required to reduce in order to meet the objective of reducing CO₂ emissions, the available supply of raw materials for geopolymers is insufficient by an order of magnitude or two and the supply is likely to decline to zero as the carbon emitting industries which produce them decline in a zero-carbon society.

Magnesium sulfo-aluminate cements (MSA) [5, 6, 7]. These new binders are produced from the calcination of mainly magnesite MgCO₃ at comparatively low temperature. The process emissions are the same as for the production of Portland cement, but the energy and temperature requirements are lower. They have comparable properties to Portland cement, but there are relatively few available deposits on the planet, the main ones being in China and the United States. They do not represent a reasonable alternative in the United Kingdom (and most of the world outside regions of production).

Wollastonite/Rankinite cement (Solidia). These binders are made from calcining limestone at 1200° C. [8]. The key difference with Portland cement is that the cure is done under a CO₂ atmosphere at 60° C. recapturing most of the CO₂ emitted during the calcination. These binders cannot be used as replacement for cement in general, but have potential for producing low-carbon, unreinforced precast elements.

Calcium sulfo-aluminate cements (CSA) [5, 6, 7]. These new binders are produced from the calcination of mainly bauxite at comparatively low temperature. They have the valuable property of hardening faster than Portland cement. However, still they require calcination in a kiln (e.g. by burning fuel), cannot be blended with common substituting cementitious materials, and bauxite is not available everywhere, such as in the UK. This approach therefore only helps alleviate partly the emissions from calcination, and suffers from scaling problems. It likely will be confined to precast applications, representing perhaps 20% of the current cement market.

Direct calcination (CCS). The LEILAC project [9] separates the limestone from the burning gas in the calciner, allowing a flow of nearly pure CO₂ to be captured effectively. This technology addresses the process emissions but would still require the burning of fuel (and hence an additional CCS process to capture the CO₂ from the fuel combustion) to reach calcination temperatures. As with all carbon capture-based technologies it heavily depends on the future development of the storage or use of the CO₂.

Alternative construction techniques and materials. There are many other existing options for construction, mostly for smaller structures: rammed earth, bricks and lime mortar, etc. These all have a place in a future zero-carbon world, but cannot replace cement at scale for all its many uses. A possible exception is timber, which has the potential to be used even in tall buildings. The emissions for the manufacturing of suitable timber elements are not negligible, however, as a kiln is required for the drying and considerable amounts of glue are used. Further, the emissions are captured by timber only if forests are maintained in perpetuity, and other concerns for ecology and biodiversity mitigate against increasing mankind's appropriation of biomass.

Calcined clays as cement replacement (LC³). Calcined clay can replace up to 50% of Portland cement, with an additional 15% substituted by ground limestone. The metakaolin contained in the clay not only works pozzolanically, but the product of this reaction can in turn form hydrates with the dissolution products of the limestone, allowing very high replacement rates [10]. Calcined at lower temperature than Portland, these widely available material are an economic way to abate a large fraction of the emissions associated with the production of cement. A limit to the amount of replacement possible is the reactivity of the Portland cement used. A higher reactivity cement could potentially allow up to 80% replacement.

Using construction and demolition wastes as raw meal for the production of new cement (CDW). Demonstration plants exist which use streams where aggregate and paste have been partly separated, and ongoing projects look at improving separation technologies [11, 12]. In current approaches, after treatment and separation of the aggregates and finely intermixed powders of sand and hydrated cement paste, calcination still occurs in kilns, resulting in emissions from the burning of fuel.

Improved structural design. Currently, buildings contain 30-40% too much embodied CO₂, largely due to poorly optimised designs and errors in the choice of frame types [13, 14]. The overall need for construction materials can therefore be reduced considerably, using known design techniques which are still under-deployed. This can never eliminate emissions but can magnify the impact of successful substitution and abatement strategies.

All the proposed routes to reduce emissions in cement production and use may have a role to play to achieve the UK target of no emissions by 2050. Nonetheless, there would remain a significant gap depending on the speed of deployment of carbon capture and storage solutions, even if these are economically viable, which is currently unproven.

The present invention has been devised in light of the above considerations.

### SUMMARY OF THE INVENTION

The present inventors have developed an alternative route to reduce emissions linked to cement production. By contrast to decarbonating the production of cement, steel, another material critical for construction, has a path to zero-carbon using well-established technologies. Recycling of scrap steel in electric arc furnaces (EAF) is already widely deployed, and if the energy source for the EAF is non-emitting, then so is the recycling process.

The present invention is based on the insight of the present inventors that cement paste can be used as a flux in the recycling of steel scrap in an electric arc furnace, forming a slag. The investigations of the present inventors reveal that the slag from such a process can have useful properties as a cement clinker.

Accordingly, in a first aspect, the present invention provides a process for the combined manufacture of steel and cement clinker, the process including the steps:
providing an electric arc furnace;
providing steel scrap;
providing cement paste derived from construction and demolition waste;
loading the steel scrap in the electric arc furnace for forming molten steel;
loading the cement paste in the electric arc furnace to act as a flux for the steel to assist in the removal of impurities from the molten steel and forming an electric arc furnace slag, wherein the heat of the molten steel promotes clinkering of the electric arc furnace slag to form clinkered electric arc furnace slag; and
removing the clinkered electric arc furnace slag from the electric arc furnace.

In a second aspect, the present invention provides cement clinker obtained by or obtainable by a process according to the first aspect.

In a third aspect, the present invention provides cement obtained by or obtainable by grinding the cement clinker of the second aspect. This may include adding a set retardant such as gypsum.

Typical temperatures in conventional cement kilns can reach up to 1450° C. On the other hand, and considering the liquidus temperature for typical steel compositions, the typical maximum operating temperature in an EAF is significantly higher, for example at least 1500° C., more typically at least 1550° C., at least 1600° C., at least 1650° C. or at least 1700° C. Industrial EAFs may have a typical maximum operating temperature of up to 1800° C. EAFs for research purposes may of course reach significantly higher temperatures. Accordingly, the EAF may have a maximum operating temperature of up to 1900° C., up to 2000° C., up to 2100° C., up to 2200° C., or up to 2300° C. for example. A suitable maximum temperature for carrying out the process of the first aspect may therefore be in a range formed by selection of any one of these lower limits with any one of these upper limits, e.g. 1500° C. to 2300° C.

The clinkered electric arc furnace slag, on removal from the electric arc furnace, is cooled from the operating temperature of the electric arc furnace. The cooling rate of the clinkered electric arc furnace slag may be such that the temperature of the clinkered electric arc furnace slag cools from the operating temperature of the electric arc furnace to 950° C. or below in a time of 20 minutes or less. More preferably this time is 15 minutes or less, still more preferably 10 minutes or less, 5 minutes or less, 4 minutes or less, 3 minutes or less, 2 minutes or less, or 1 minute or less. Cooling from the furnace temperature to room temperature may suitably take place in 40 minutes or less, more preferably in 20 minutes or less.

The cement paste added to the electric arc furnace may be pelletised before being added to the electric arc furnace. At least at an industrial scale, this is considered to make the cement paste easier to handle for adding into the electric arc furnace.

The cement paste derived from construction and demolition waste may include some particles derived from sand and/or aggregates in the construction and demolition waste. Specifically, the cement paste may include up to 50% by weight of silicate from sand and/or aggregates. These derive from the concrete component of the construction and demolition waste.

Different metallurgical operations may take place in the electric arc furnace. Depending on the metallurgical operation(s) being carried out (e.g. melting only, fine alloying etc.) there may be formed EAF slag and/or ladle slag. It is considered that the present invention has utility for EAF slag and ladle slag. In some embodiments, the present invention has particular utility for EAF slag. Note that in the art EAF slag may be referred to as black slag and ladle slag may be referred to as white slag.

The cement paste may be combined with one or more additional materials to assist with fluxing of the steel and/or to promote and preferably optimise the production of Alite (tricalcium silicate). For example, CaO may be one such additional material. Preferably the ratio of cement paste to additional material is in the range defined by 75 wt % cement paste: 25 wt % additional material at one limit to 99 wt % cement paste: 1 wt % additional material at the other limit. The upper end of the range may instead be:
80 wt % cement paste: 20 wt % additional material
85 wt % cement paste: 15 wt % additional material
90 wt % cement paste: 10 wt % additional material
95 wt % cement paste: 5 wt % additional material

The additional material may be CaO entirely. Alternatively it may not include CaO. Alternatively it may be CaO with one or more further materials.

The clinkered electric arc furnace slag may be Portland cement clinker. For example, it may be Portland cement clinker according to EN197-1.

The cement produced from the Portland cement clinker may be CEM I cement. This is sometimes referred to as ordinary Portland cement (OPC).

The clinkered electric arc furnace slag from the process may therefore be a hydraulic material. It may consist of at least two-thirds by mass of calcium silicates. The calcium silicates may be 3CaO·SiO₂, 2CaO·SiO₂, or a combination of 3CaO·SiO₂ and 2CaO·SiO₂. Put another way, the calcium silicates may be Alite, Belite, or a combination of Alite and Belite. The ratio of CaO to SiO₂ may be not less than 2.0. The magnesium oxide content (MgO) may not exceed 5.0% by mass.

Considering the calcium silicates content of the clinkered electric arc furnace slag, the proportion of Alite may be at least 1 wt %, at least 2 wt %, at least 3 wt %, at least 4 wt %, at least 5 wt %, at least 10 wt %, at least 15 wt %, at least 20 wt %, at least 25 wt %, at least 30 wt %, at least 35 wt %, at least 40 wt %, at least 45 wt %, at least 50 wt %, at least 55 wt %, at least 60 wt %, at least 65 wt %, at least 70 wt %, at least 75 wt %, at least 80 wt %, at least 85 wt %, at least 90 wt %, at least 95 wt %, or about 100 wt %. The balance calcium silicates may be Belite.

The invention includes the combination of the aspects and optional features described except where such a combination is clearly impermissible or expressly avoided.

### SUMMARY OF THE DRAWINGS

Embodiments and experiments illustrating the principles of the invention will now be discussed with reference to the accompanying drawings in which:

FIG. 1 shows a schematic flow diagram of the present industrial production of concrete and the present industrial recycling of steel.

FIG. 2 shows a schematic flow diagram of how an embodiment of the present invention is integrated with the industrial recycling of steel.

FIG. 3 shows a schematic ternary phase diagram for the CaO—SiO₂—Al₂O₃ system, overlaid with typical compositional areas for cement paste and EAF basic flux.

FIG. 4 shows the same schematic ternary phase diagram for the CaO—SiO₂—Al₂O₃ system as in FIG. 3, but overlaid with the compositions of cement phases C₃S, C₂S and C₃A and with typical compositional areas for Portland cement and for EAF slag.

FIG. 5 shows the results of powder XRD analysis and peak identification for the w/c 0.4 sample produced in Experiment 1.

FIG. 6 shows the results of powder XRD analysis and peak identification for the w/c 0.6 sample produced in Experiment 1.

FIG. 7 shows the results of powder XRD analysis and peak identification for the w/c 0.4 sample produced in Experiment 2.

### DETAILED DESCRIPTION OF THE INVENTION

Aspects and embodiments of the present invention will now be discussed with reference to the accompanying drawings. Further aspects and embodiments will be apparent to those skilled in the art. All documents mentioned in this text are incorporated herein by reference.

In the present disclosure, the inventors demonstrate that it is possible to recycle construction and demolition waste (CDW) into new high-quality Portland cement, using electric arc furnace plants to make use of the high temperatures for the electrical co-production of steel and cement. This has the potential to allow the production of zero-carbon cement, at scale.

Typical temperatures in conventional cement kilns can reach up to 1450° C. On the other hand, and considering the liquidus temperature for typical steel compositions, the typical maximum operating temperature in an EAF is significantly higher, for example at least 1500° C., more typically at least 1550° C., at least 1600° C., at least 1650° C. or at least 1700° C. Industrial EAFs may have a typical maximum operating temperature of up to 1800° C. EAFs for research purposes may of course reach significantly higher temperatures. Accordingly, the EAF may have a maximum operating temperature of up to 1900° C. or up to 2000° C. for example. A suitable temperature for carrying out the clinkering process may therefore be in a range formed by selection of any one of these lower limits with any one of these upper limits, e.g. 1500° C. to 2000° C.

Furthermore, the inventors have realised that it is possible to make use of the high temperatures in electric arc furnaces (compared with temperatures available in conventional cement kilns) to produce ultra-reactive cements. This can allow higher levels of substitution, lowering the required volumes of Portland cement for a specific application.

As summarised in Table 1, most options for the replacement of cement (discussed above) have similar, if lower calcination emissions, except for geopolymers, which has no significant future due to the unavailability of the raw materials. The “+”, “−” and “=” mark improvement/degradation/equal (respectively) compared to Portland for emissions, the economic case for large-scale deployment, the potential to be a full-scale replacement, and the expected supply chain disruption. The present invention concentrates on the concept indicated as CDW+EAF, i.e. the combination of electric arc furnace recycling of steel with the use of cement paste derived from construction and demolition waste as flux for the EAF.

TABLE 1
Summary of the currently proposed options for the replacement of cement.

| Option | Process | Calcination | Economics | Scalability | Supply chain | Notes |
|---|---|---|---|---|---|---|
| Geopolymers | +++ | +++ | + | −−− | = | no future availability |
| Timber | +++ | ++ | + | + | + | only some uses |
| CCS | +++ | = | ? | ? | +++ | long-term option |
| LC³ | ++ | + | ++ | ++ | ++ | needs available clay |
| Solidia | ++ | + | ? | + | −− | precast, unreinforced |
| Other | ++ | + | ? | −− | −− | small scale options |
| CSA | + | ++ | ++ | + | ++ | mostly precast |
| MSA | = | + | −−− | −− | −−− | rare materials |
| Design | ++ | ++ | +++ | +++ | +++ | with other solutions |
| CDW | +++ | = | ++ | +++ | = | needs rerouting CDW |
| CDW + EAF | +++ | +++ | ? | +++ | −− | needs matching steel |
| | | | | | | demand |

Of course, in order to achieve zero greenhouse gas emissions a number of techniques would be developed and combined into an industrial strategy. Many of the basic technologies considered here therefore already exist at the state of large industrial demonstrators. This is true for concrete separation into paste and aggregate streams, or the production of calcined-clay limestone mixes. Integration of these can significantly abate emissions in cement production, but do not solve the problem of emissions from calcination. The present inventors consider that integrated steel recycling and clinkering provides an important step. It is considered that the clinkering process in an environment which has considerable excess iron has not been studied in detail, and many aspects of the strength development of Portland cement are not fully understood [15], let alone mixes with high levels of substitution.

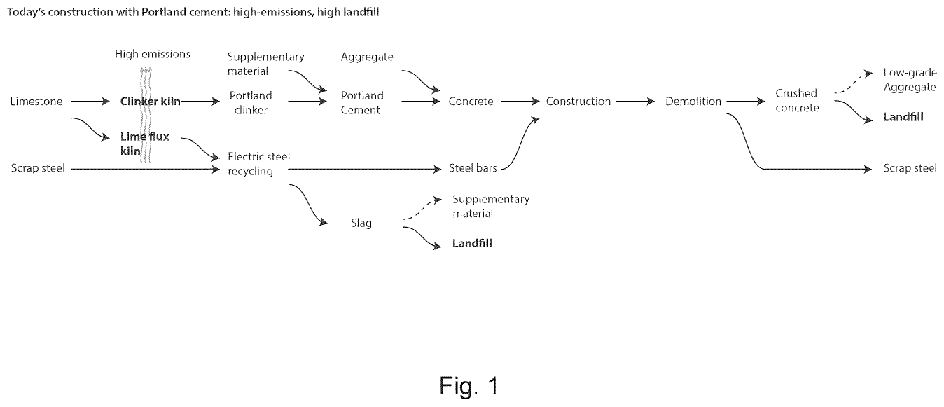

FIG. 1 shows a schematic flow diagram of the present industrial production of concrete and the present industrial recycling of steel. Taking the production of cement first, this is formed as already described, using a cement kiln. One of the main raw materials for conventional cement production is limestone. Limestone calcination is responsible for the process emissions of cement. Limestone is used because of its very wide availability, low price, and easy quarrying. Lime from calcination of limestone may also be used as flux for EAF steel recycling. Slag from EAFs is not usually considered to be commercially valuable, and may for example be disposed of in landfill. Concrete structures, after the end of their useful life and demolition, are also usually disposed of in landfill.

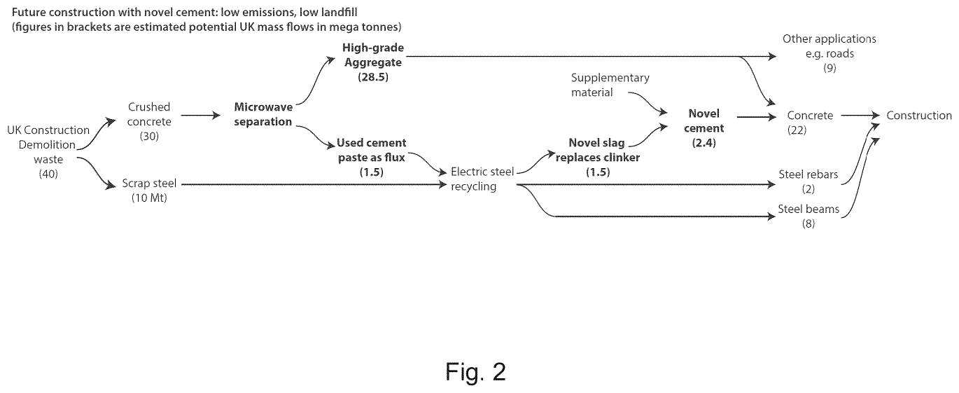

FIG. 1 can be contrasted with FIG. 2, which shows a schematic flow diagram of how an embodiment of the present invention is integrated with the industrial recycling of steel. In FIG. 2, crushed concrete derived from CDW is subjected to a separation process in order to separate used cement paste and aggregate (sand and stone). Microwave separation is considered to be useful, but other separation process may be used in order to provide used cement paste. As described in more detail below, the used cement paste can be loaded into an EAF (optionally with additional components) in order to be used as a flux in the EAF to assist in the operation of the EAF to melt and treat the steel scrap in the EAF. The resultant slag forms cement clinker that can be pulverised and treated to form cement which subsequently can be used to form new concrete. Optionally, the aggregate from the separation process can be re-used in the new concrete. Also optionally, the steel produced from the EAF can be used in construction, for example as rebar in reinforced concrete.

In comparison with the process shown in FIG. 1, the cement kiln CO₂ emissions from calcination of limestone are avoided. Additionally, lime kiln CO₂ emissions from calcination of limestone (for producing CaO flux for the EAF) are also avoided.

Accordingly, in general terms embodiments of the present invention provide a route to economical, industrial scale zero-carbon cement production. This is achieved by clinkering cement paste derived from demolition waste, providing the necessary calcium in an EAF powered from low-carbon (e.g. renewable) energy.

Concrete from CDW is a relatively abundant source of carbon-free calcium, however it is possible that the volumes required could not be reached from demolition waste alone. In the UK, approximately 30 Mt of concrete is recovered annually from demolitions, suggesting about 1.5 Mt of cement paste could be recovered with an efficiency of 40%. FIG. 2 indicates how the recovered cement paste and the separated aggregate can subsequently be used in the context of an embodiment of the present invention. FIG. 2 indicates that the combined production of steel and cement without greenhouse gas emissions (or without significant greenhouse gas emissions) is possible in symbiosis.

Separating the cement paste from the aggregates in CDW recycled concrete has been tested at the laboratory scale [11]. One suitable method is to microwave broken concrete to separate paste and aggregates. This mimics the process which occurs in a fire when concrete spalls by debonding paste and aggregates. The paste and the aggregates lose cohesion when microwaved, the mechanism for which is not currently fully understood. This process can perhaps be understood based on dense cracking in the visco-elastic medium that is concrete [17, 18, 19].

The decohered paste and aggregate rubble are then separated into an aggregate and a paste stream. There are various main options for this: (i) exploiting differences in the specific densities to separate the elements by centrifugation; (ii) separating the smaller paste fragments by sieving; (iii) powder separation using a vortex separator.

It is possible to characterise cement paste obtained as described above. Durability tests can be performed using the standard protocols for sulfate resistance, alkali-silica reaction expansion [20, 21], and chloride ingress. Because of the raw material, the cements produced are more likely to resemble blends, with co-ground sand grains behaving either like filler or pozzolana, which is considered to be good for their durability properties.

It is also possible to consider the visco-elastic properties of the recycled cement mixes. Early-age creep is an important determinant in early-age cracking and shrinkage, and longer-term creep is an important factor in the design of post-tensioned structures. This is particularly relevant as the construction industry will need to move to more optimised constructions techniques, in particular precast elements.

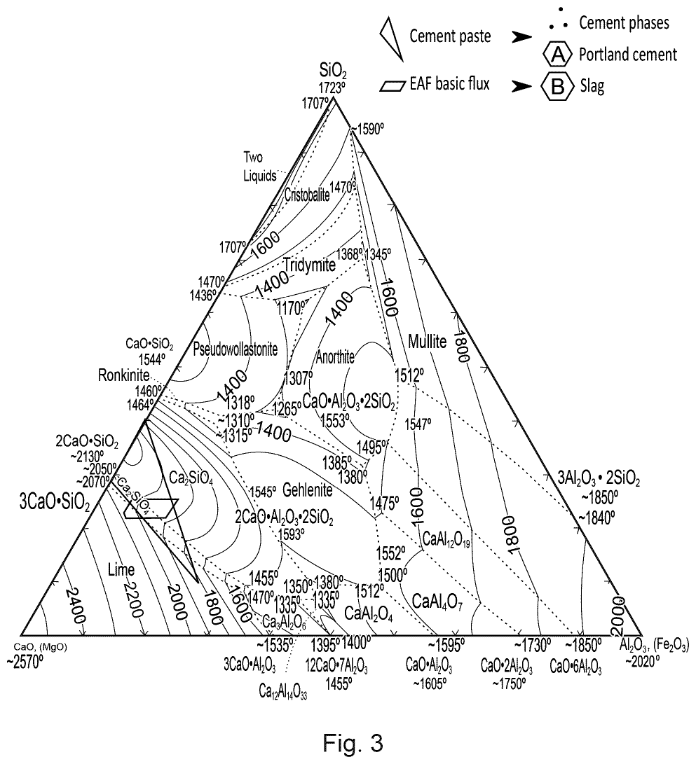

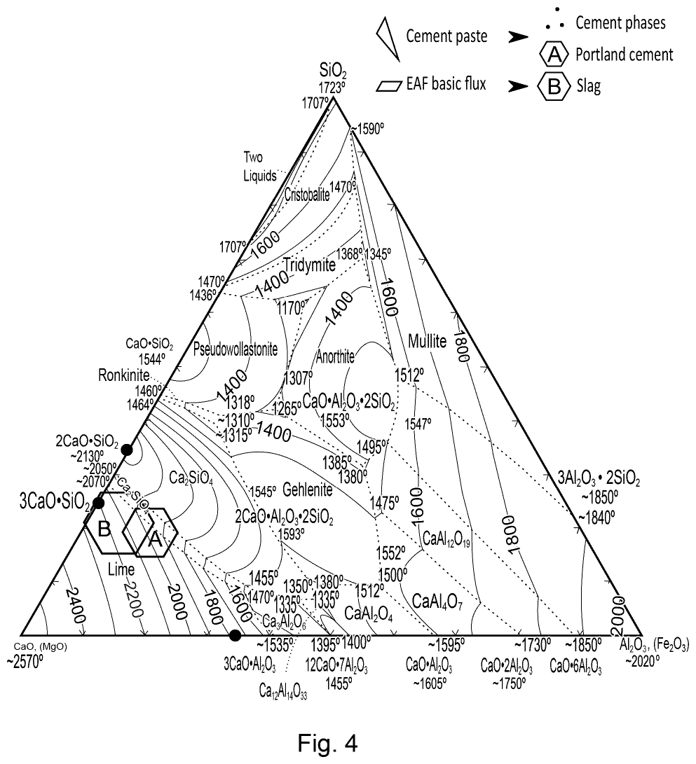

FIG. 3 shows a schematic ternary phase diagram for the CaO—SiO₂—Al₂O₃ system, overlaid with typical compositional areas for cement paste and EAF basic flux. FIG. 4 shows the same schematic ternary phase diagram for the CaO—SiO₂—Al₂O₃ system as in FIG. 3, but overlaid with the compositions of cement phases C₃S, C₂S and C₃A and with typical compositional areas for Portland cement and for EAF slag. These diagrams are created from references 22, 23, 24 and 25. The purpose of including FIGS. 3 and 4 is to show the compositional similarity between an EAF basic flux and a cement paste. As shown in FIGS. 3, these compositions overlap in the CaO—SiO₂—Al₂O₃ compositional space. By “basic” flux, we refer to the tendency of fluxes used in EAFs to be basic in order to avoid the flux/slag corroding the refractory bricks lining the EAF.

The black dots on FIG. 4 show the main cement phases C₃S, C₂S and C₃A. In a typical Portland cement, these phases combine to give an average composition illustrated by space A on FIG. 4. On the other hand, a typical EAF flux forms an EAF slag with an average composition illustrated by space B on FIG. 4. As can be seen, in this exemplary illustration, A and B overlap. Together, FIGS. 3 and 4 indicate that it may be possible to use cement paste as an EAF flux, form an EAF slag with the flux and that, compositionally, it may be possible to form the required phases in the slag for Portland cement clinker.

Accordingly, using a steel recycling EAF as a kiln where the clinkering process occurs on top of the molten steel, can enable the production of zero carbon cement. The temperatures reached in an EAF can go above 1800° C., well above the 1250° C. lower stability limit for C₃S (Alite), the main Portland phase or the 1450° C. used in commercial kilns. Such higher temperatures open the possibility of producing highly reactive cements.

It is therefore possible in an industrial context to carry out combined cement and steel production in an EAF plant. This exploits the high temperatures reached by the EAF without burning fuel for the purpose of making cement. By adding a source of calcium to the melt in the form of recovered CDW paste, the slag produced is compositionally close to a commercial Portland cement as shown by FIGS. 3 and 4. As an additional benefit, this de-sulphurs the steel.

It should be noted that it is known to use various slags (e.g. blast furnace slag, basic oxygen furnace slag, EAF slag and ladle furnace slag) for different purposes in the context of construction materials. They have been investigated, at least at the laboratory scale, for the substitution of binder, fine aggregates or coarse aggregates in concrete. However, the present inventors consider that previous work has not sufficiently considered the importance of Alite and Belite formation and phase quenching that would be required in order to provide Portland clinker, for example.

As discussed below, in embodiments of the present invention, it is considered that the EAF slag should be cooled relatively quickly from the EAF in order to quench in the required Portland cement phases. Clearly this cooling should not be carried out using water, in view of the reactivity of Portland cement clinker with water. Accordingly, gas (e.g. air) quenching can be used, or heat sink quenching, or a combination of these.

Initial trials produced a slag with very high iron content, approaching 80% Wustite (FeO) measured by XRD and approaching 70% FeO measured by SEM-EDS. It is assumed that this was oxidised iron from steel entering the cement slag. The method of melting was adapted in order to reduce the FeO content in slag. This included adding carbon to the scrap melt to oxidise in preference to Fe, removing top layer of scrap melt using a chill plate immediately before adding cement paste, removing the slag soon after fluxing. By using this method, the FeO content of subsequent slag samples was found to be 38-51% (SEM-EDS analysis). It is considered that this is closer to, but still higher than, the FeO content of a typical EAF slag (typically up to 35%).

In all of the trials carried out, melting and complete fluxing was successful.

Samples of cement slag were analysed using SEM-EDS to illustrate composition.

TABLE 2
Clinker material mineral chemical composition

| | Cement Chemist Notation, | |
|---|---|---|
| Common Name | where appropriate | Chemical Formula |
| Alite | C₃S | Ca₃SiO₅ |
| Belite | C₂S | Ca₂SiO₄ |
| Aluminate | C₃A | 3CaO•Al₂O₃ |
| Ferrite | C₄AF | 4CaO•Al₂O₃•Fe₂O₃ |
| Periclase | MgO | MgO |
| Free Lime | CaO | CaO |

Table 2 shows the typical phases found in Portland cement clinker. The approximate bulk mineral composition of typical clinker is: 50-70% alite, 15-30% belite, 5-10% aluminate, 5-15% ferrite, 2% free lime, 2% periclase.

Bullard investigated the effect of cooling of cement clinker on exit from a cement kiln. According to the work reported by Bullard [29], the cooling rate from the kiln temperature to 950° C. is considered to be determinative of the mineralisation in the clinker-below 950° C. the minerals in clinker are considered to be fixed. Bullard investigated cooling rates between 1500° C. to 950° C. in the range 550° C./min to 6.9° C./min. On the basis of that work, it is considered that cooling of clinker from the furnace temperature to 950° C. should take place over a time of 20 minutes or less, more preferably 15 minutes or less, still more preferably 10 minutes or less, 5 minutes or less, 4 minutes or less, 3 minutes or less, 2 minutes or less, or 1 minute or less. Cooling from the furnace temperature to room temperature may suitably take place in 40 minutes or less, more preferably in 20 minutes or less.

### Bogue Calculation

The Bogue calculation is used empirically to calculate the approximate proportions of the four main minerals in Portland cement clinker. We refer to ASTM C150 which gives full details.

The calculation assumes that the four main clinker minerals are pure minerals with compositions set out in Table 2 above: Alite, Belite, Aluminate, Ferrite.

Clinker is typically made by combining lime and silica and also lime with alumina and iron. If some of the lime remains uncombined, then it is necessary to subtract this from the total lime content before carrying out the calculation in order to get the best estimate of the proportions of the four main clinker minerals present. For this reason, a clinker analysis normally gives a figure for uncombined free lime.

The calculation takes the following steps:

Firstly, according to the assumed mineral compositions, ferrite is the only mineral to contain iron. The iron content of the clinker therefore fixes the ferrite content.

Secondly, the aluminate content is fixed by the total alumina content of the clinker, minus the alumina in the ferrite phase. This can now be calculated, since the amount of ferrite phase has been calculated.

Thirdly, it is assumed that all the silica is present as belite and the next calculation determines how much lime is needed to form belite from the total silica content of the clinker. There will be a surplus of lime. Fourthly, the lime surplus is allocated to the belite, converting some of it to alite.

In practice, the above process of allocating the oxides can be reduced to the following equations, in which the oxides represent the weight percentages of the oxides in the clinker:

C₃S=4.0710CaO−7.6024SiO₂−1.4297Fe₂O₃−6.7187Al₂O₃

[i.e. C₃S=4.0710C−7.6024S−1.4297F−6.7187A]

C₂S=8.6024SiO₂+1.0785Fe₂O₃+5.0683Al₂O₃−3.0710CaO

[i.e. C₂S=8.6024S+1.0785F+5.0683A−3.0710C]

C₃A=2.6504Al₂O₃−1.6920Fe₂O₃

[i.e. C₃A=2.6504A−1.6920F]

C₄AF=3.0432Fe₂O₃

[i.e. C₄AF=3.0432F]

If the compositions of the starting materials are known, then these can be used to carry out the Bogue calculation. Alternatively, it is possible to carry out the calculation based on an elemental compositional analysis of the clinker (e.g. using EDS carried out in an SEM). In that case, however, it is typically not known how much free lime should be taken into account, and accordingly the Bogue calculation as applied to the embodiments discussed herein is adapted as necessary.

### Experiment 1

### Sample Preparation

To prepare samples resembling the paste found in Construction and Demolition Waste (CDW) paste samples were prepared with a mass water to cement ratio (w/c) of 0.4. These were left to hydrate for 28 days sealed at room temperature before they were crushed into a powder.

One type of cement was investigated and reported here, a CEM I (a pure Portland cement).

### Sample Treatment

The samples were pre-heated at 500° C. for 30 minutes, then added to the EAF containing molten scrap for 5-15 minutes. In the EAF there was 8 times as much steel as cement by mass. The resulting slag was removed from the furnace, cooled on a copper plate and ground to <125 μm. It is considered that the cooling experienced by the slag ensured that the slag temperature was less than 950° C. within less than 1 minute.

For the w/c 0.4 sample, the melt temperature before the cement paste addition was 1600° C., the melt temperature at slag removal was 1635° C., and the time from the end of cement paste addition to the slag removal was 5 minutes.

For the w/c 0.6 sample, the melt temperature before the cement paste addition was 1556° C., the melt temperature at slag removal was 1636° C., and the time from the end of cement paste addition to the slag removal was 15 minutes.

### Slag Characterisation

The ground slag can be analysed using SEM-EDS in order to provide information on the elemental composition of the slag.

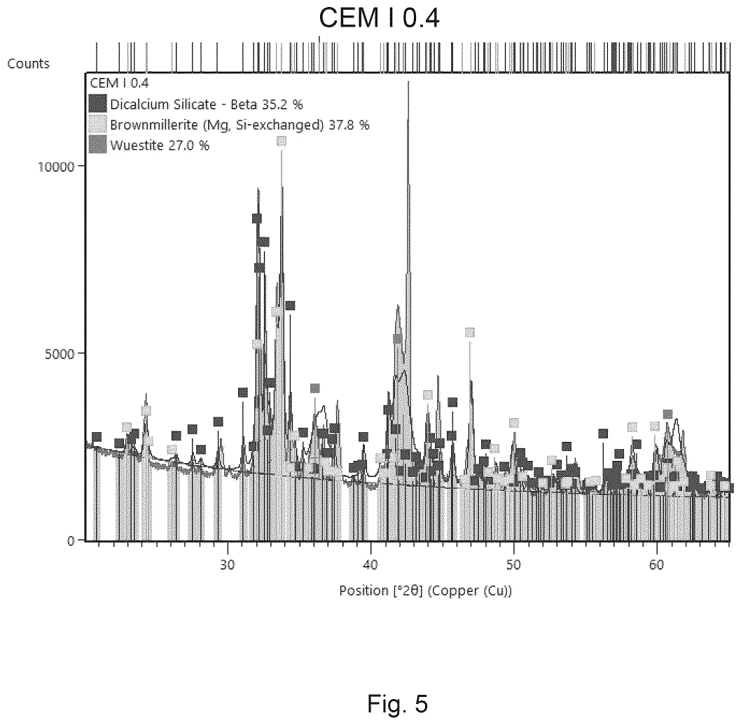

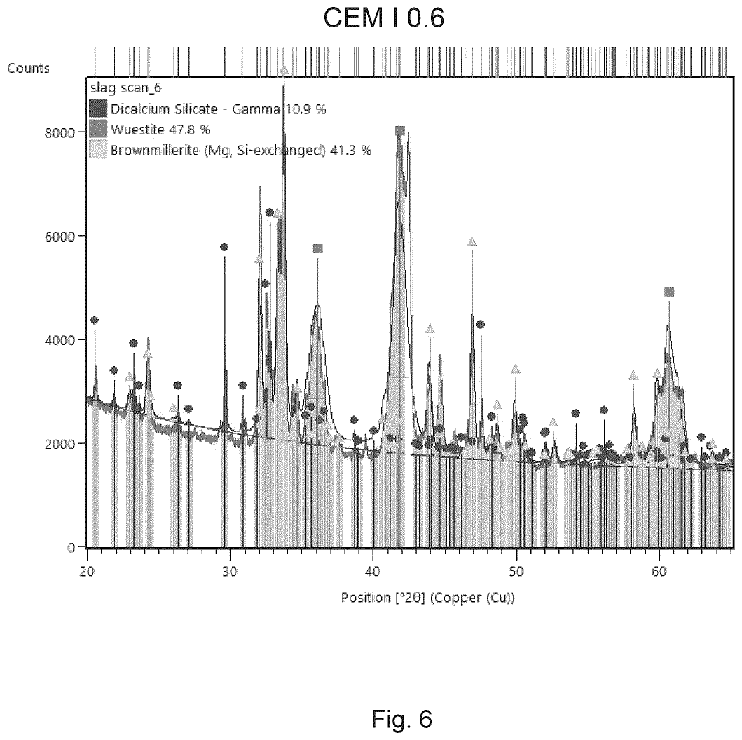

The ground slag was analysed using X-Ray Diffraction (XRD) combined with Rietveld analysis, which can quantitatively identify all the crystalline phases present. FIG. 5 shows the XRD analysis for the CEM I 0.4 sample. FIG. 6 shows the XRD analysis for the CEM I 0.6 sample.

### Results

A first attempt had an uncharacteristically high amount of F (FeO). This was due to a combination of high oxidation in the melt and furnace geometry. These issues were remediated in a second batch. The amount of FeO in the second batch was still higher than would typically be expected for an EAF.

Fluxing was normal. This indicates that recycled CDW paste can work as a flux for EAF operation.

The composition of the EAF slag, obtained by XRD was as follows.

TABLE 3
Composition of EAF slag in Experiment 1

| | | Sample: | Sample: |
|---|---|---|---|
| | Chemical Formula | CEM I w/c = | CEM I w/c = |
| Compound name | (cement notation) | 0.4 | 0.6 |
| Wustite | F | 27.0 | 47.8 |
| (Iron oxide) | | | |
| Brownmillerite | C₄AF | 37.8 | 41.3 |
| (Aluminoferrite) | | | |
| Dicalcium silicate | C₂S | 35.2 | 10.9 |
| (Belite) | | | |

This indicates that the process can yield a Belite (C₂S) cement. This is not the cement type which we want to produce ultimately, but it is a viable cement and a precursor to Portland cement.

### Analysis

To produce Alite (C₃S), there must be an excess of calcium. The lime saturation factor (LSF), as calculated by Bogue is:

LSF=C/(2.8S+1.2A+0.65F)

Based on the above results, we have
F=27+72/(56*4+102+72)*37.8=33.8
A=102/(56*4+102+72)*37.8=9.7
S=60/(56*2+60)*35.2=12.3
C=56*2/(56*2+60)*35.2=22.9
LSF=0.33

This suggests that to reach typical cement plant LSF, we would need a mix of 29% CaO-71% recycled paste. This would produce C₃S instead of C₂S. Bogue calculations are empirical and based on the normal operating temperature of kilns. Higher temperatures, as experienced in an EAF, thermodynamically favour the formation of C₃S. Therefore, this calculated additional CaO requirement is expected to be a ceiling. Based on similar calculations 25% CaO added to the mix is expected to yield a majority C₃S result.

In a full-sized EAF, the conditions are much more favourable as the F in contact with the slag is much less (perhaps half). This suggests that in a full scale industrial process, the amount of lime required would be at most 10-15%. This represents a 90-85% abatement in the process emissions associated to both cement and recycled steel production.

It is noted that the analysis shows that no C₃S was present in the ground EAF slag, whereas the nature of the starting materials is that there should have been some input into the furnace. Without wishing to be bound by theory, the inventors consider that it is possible that the 500° C. pre-treatment for 30 minutes may affect the results.

It is also noted that different results were seen between the 0.4 w/c and the 0.6 w/c cement pastes. There are no particular reasons these should have yielded different results, aside from the different amounts of C₃S left in the sample when prepared to be used as a flux.

Experiment 1 is therefore considered to teach that recycled cement paste can work as a flux for EAF operation. It is considered that a small addition of lime will be conducive to the production of high Alite.

### Experiment 2

Experiment 2 corresponded to Experiment 1 except that only a mass water to cement ratio (w/c) of 0.4 was used and a lime additive was included.

The cement investigated is a CEM I (a pure Portland cement). The lime used as additive was industrial grade (98% pure).

### Sample Treatment

The samples were pre-heated at 500° C. for 30 minutes, then added to the EAF containing molten scrap for 5-15 minutes as a flux, with a ratio of 75% cement paste and 25% lime. The resulting slag was removed from the furnace, cooled on a copper plate and ground to <125 μm.

### Slag Characterisation

The ground slag was analysed using SEM-EDS.

The ground slag was analysed using X-Ray Diffraction (XRD) combined with Rietveld analysis, which can quantitatively identify all the crystalline phases present.

### Results

Based on SEM-EDS analysis, the oxide composition is:
F: 6.32
A: 6.91
S: 16.85
C: 66.43

In order to assess the phases present, we use the Bogue calculation method:

Thus,

C₄AF=3.043 F=19.2

C₃A=2.65 A−1.692 F=7.6

The amount of free lime is not exactly known. However, it is possible to say with certainty that there was an excess, and we cannot have less than 0% C₂S. From this we deduce that we have 64% C₃S if no C₂S was produced:

C₃S=4.071(C−free lime)−7.600 S−6.718 A−1.430 F=64

free lime=6.43

C₂S=2.867 S−0.7544 C₃S=0

We now explain the rationale behind these calculations in more detail. In both Experiment 1 and Experiment 2, the amount of free lime will be in the range between zero and the amount of lime added.

In Experiment 1, there was not enough lime in order to form Alite, and the LSF was very low. Indeed, the XRD analysis found no free lime. Accordingly, in Experiment 1, there was not enough lime in order to reach a LSF of 1, based on the XRD of Experiment 1. Therefore the lowest amount of free lime giving positive quantities for all phases was selected. That amount is 6%. In principle the maximum possible amount of free lime is 17%. This is derived based on the proportion of lime added (25%) and the proportion of measured calcium in the elemental analysis (about 66%). At 17% free lime the Alite and Belite predicted are 19.3% and 33.9%, respectively.

In the view of the inventors, 17% free lime represents the worst case scenario, with 53% Alite plus Belite. However, in the view of the inventors this scenario is not technically realistic, because it implies that there is a lot of free lime despite not being lime saturated and assumes that the lime added did not react at all. This is highly unlikely, in particular from a thermodynamic assessment based on the temperature and the residence time in the EAF.

Accordingly, considering the mass of the sample, we can provide the full range of possible outcomes as:
Alite proportion in the range 64% to 19.3%
Belite proportion in the range 0% to 33.9%

In the view of the inventors, for the reasons explained, it is considered most likely that the phase composition of the sample is towards the high Alite proportion end of the range expressed above. It is considered that the other end of the range, in which there is 19.3% Alite and 33.9% Belite is highly unlikely.

Further, the inventors consider that for a sufficient residence time, 64% Alite is the outcome of this mixture. The inventors also comment that the Bogue calculation is known to underestimate the amount of Alite (by 3-4% absolute, typically).

Accordingly, the inventors have confidence based on the calculations and explanations above that the sample from Experiment 2 was a high Alite cement.

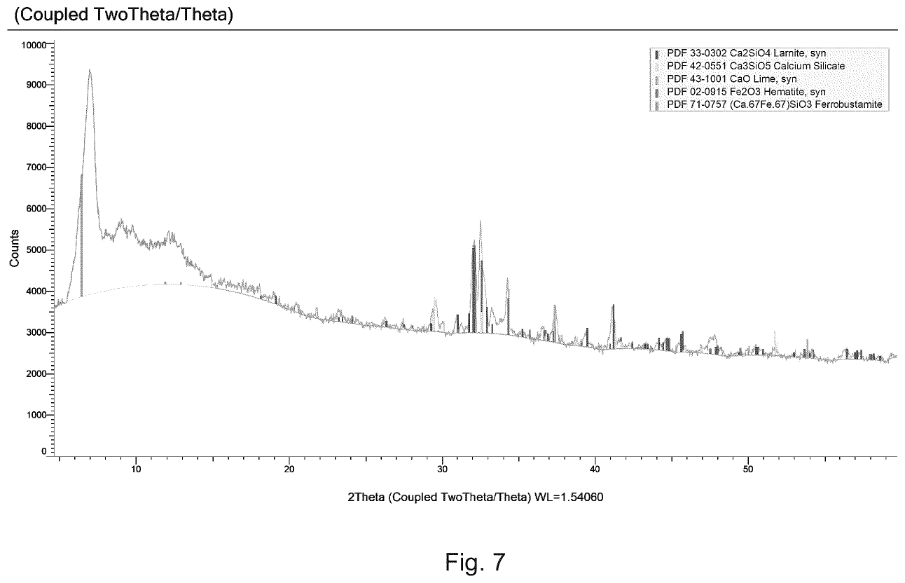

FIG. 7 shows the results of powder XRD analysis and peak identification for the w/c 0.4 sample produced in Experiment 2.

The composition of the EAF slag, obtained by XRD was as follows.

TABLE 4
Composition of EAF slag from Experiment 2

| | | Sample: |
|---|---|---|
| | Chemical Formula | CEM I w/c = 0.4 |
| Compound name | (cement notation) | plus 25% CaO |
| Wustite | F | 2.5 |
| (Iron oxide) | | |
| Brownmillerite | C₄AF | 0 |
| (Aluminoferrite) | | |
| Dicalcium silicate (Belite) | C₂S | 46.7 |
| Tricalcium silicate (Alite) | C₃S | 24 |
| Lime | C | 2.4 |
| Ferrobustamite | CFS | 24.4 |

The sample had a large background problem so quantification was uncertain. More than 70% Alite+Belite was formed, although more Belite than Alite according to this analysis. A phase tentatively identified as ferrobustamite was also identified.

### Analysis

Formally speaking, this test indicates that it is possible to produce a Portland clinker using the present invention. According to EN197-1:

Portland cement clinker is a hydraulic material which shall consist of at least two-thirds by mass of calcium silicates (3CaO·SiO₂ and 2CaO·SiO₂), the remainder consisting of aluminium and iron containing clinker phases and other compounds. The ratio of CaO to SiO₂ shall not be less than 2.0. The magnesium oxide content (MgO) shall not exceed 5.0% by mass.

It is clear that the use of 25% addition of CaO is an excess. It is considered that reducing the amount of CaO added further improves the quality of the cement clinker produced using the invention.

In view of the formation of a significant proportion of Alite in the EAF slag produced in Experiment 2, it is therefore demonstrated that the requirements for the formation of Portland cement clinker are satisfied.

The features disclosed in the foregoing description, or in the following claims, or in the accompanying drawings, expressed in their specific forms or in terms of a means for performing the disclosed function, or a method or process for obtaining the disclosed results, as appropriate, may, separately, or in any combination of such features, be utilised for realising the invention in diverse forms thereof.

While the invention has been described in conjunction with the exemplary embodiments described above, many equivalent modifications and variations will be apparent to those skilled in the art when given this disclosure. Accordingly, the exemplary embodiments of the invention set forth above are considered to be illustrative and not limiting. Various changes to the described embodiments may be made without departing from the spirit and scope of the invention.

For the avoidance of any doubt, any theoretical explanations provided herein are provided for the purposes of improving the understanding of a reader. The inventors do not wish to be bound by any of these theoretical explanations.

Any section headings used herein are for organizational purposes only and are not to be construed as limiting the subject matter described.

Throughout this specification, including the claims which follow, unless the context requires otherwise, the word “comprise” and “include”, and variations such as “comprises”, “comprising”, and “including” will be understood to imply the inclusion of a stated integer or step or group of integers or steps but not the exclusion of any other integer or step or group of integers or steps.

It must be noted that, as used in the specification and the appended claims, the singular forms “a,” “an,” and “the” include plural referents unless the context clearly dictates otherwise. Ranges may be expressed herein as from “about” one particular value, and/or to “about” another particular value. When such a range is expressed, another embodiment includes from the one particular value and/or to the other particular value. Similarly, when values are expressed as approximations, by the use of the antecedent “about,” it will be understood that the particular value forms another embodiment. The term “about” in relation to a numerical value is optional and means for example+/−10%.

### REFERENCES

A number of publications are cited above in order to more fully describe and disclose the invention and the state of the art to which the invention pertains. Full citations for these references are provided below.

The entirety of each of these references is incorporated herein.
[1] Julian Allwood, Jose Azevedo, Adam Clare, Christopher Cleaver, Jonathan Cullen, Cyrille Dunant, Teppo Fellin, William Hawkins, lan Horrocks, Philippa Horton, et al. Absolute zero, 2019.
[2] John L Provis and Susan A Bernal. Geopolymers and related alkali-activated materials. Annual Review of Materials Research, 44:299{327, 2014.
[3] MB Mohd Salahuddin, M Norkhairunnisa, and F Mustapha. A review on thermophysical evaluation of alkali-activated geopolymers. Ceramics International, 41(3):4273{4281, 2015.
[4] Nicoletta Toniolo and Aldo R Boccaccini. Fly ash-based geopolymers containing added silicate waste. A review. Ceramics International, 43(17): 14545{14551, 2017.
[5] Frank Bullerjahn, Maciej Zajac, and Mohsen Ben Haha. Csa raw mix design: effect on clinker formation and reactivity. Materials and Structures, 48(12):3895{3911, 2015.
[6] Frank Bullerjahn, Dirk Schmitt, and Mohsen Ben Haha. Method for producing ternesite-belite calcium sulfoaluminate clinker, Jun. 30, 2015. U.S. Pat. No. 9,067,825.
[7] Natechanok Chitvoranund, Frank Winnefeld, Craig W Hargis, Sakprayut Sinthupinyo, and Barbara Lothenbach. Synthesis and hydration of alite-calcium sulfoaluminate cement. Advances in Cement Research, 29(3): 101{111, 2017.
[8] Sean Quinn and Sadananda Sahu. Compositions and methods for controling setting of carbonatable calcium silicate cements containing hydrating materials, 2019. U.S. Pat. No. 10,196,311.
[9] Mark Sceats and Adam Vincent. Direct separation calcination technology for carbon capture: Demonstrating a low cost solution for the lime and cement industries in the leilac project. In 14th Greenhouse Gas Control Technologies Conference Melbourne, pages 21{26, 2018.
[10] Karen Scrivener, Fernando Martirena, Shashank Bishnoi, and Soumen Maity. Calcined clay limestone cements (Ic3). Cement and Concrete Research, 114:49{56, 2018.
[11] Nicholas Lippiatt and Florent Bourgeois. Investigation of microwave-assisted concrete recycling using single-particle testing. Minerals Engineering, 31:71{81, 2012.
[12] Heesup Choi, Myungkwan Lim, Hyeonggil Choi, Ryoma Kitagaki, and Takafumi Noguchi. Using microwave heating to completely recycle concrete. Journal of Environmental Protection, 2014, 2014.
[13] Cyrille F Dunant, Micha I P Drewniok, Stathis Eleftheriadis, Jonathan M Cullen, and Julian M Allwood. Regularity and optimisation practice in steel structural frames in real design cases. Resources, Conservation and Recycling, 134:294{302, 2018.
[14] Cyrille F. Dunant, Micha I P. Drewniok, John J. Orr, and Julian M. Allwood. Good early stage design decisions can halve embodied CO₂ and lower structural frames' cost. Structures, submitted, 2020.
[15] Cyrille F Dunant, Jose Granja, Amaud Muller, Miguel Azenha, and Karen L Scrivener. Microstructural simulation and measurement of elastic modulus evolution of hydrating cement pastes. Cement and Concrete Research, 130:106007, 2020.
[16] M De O Carvalho. Theoretical energy requirement for burning clinker. Cement and concrete research, 29(5):695{698, 1999.
[17] Cyrille F Dunant and Karen L Scrivener. Micro-mechanical modelling of alkali-silica-reaction-induced degradation using the amie framework. Cement and Concrete research, 40(4):517{525, 2010.
[18] Alain B Giorla, Yann Le Pape, and Cyrille F Dunant. Computing creep-damage interactions in irradiated concrete. Journal of Nanomechanics and Micromechanics, 7(2):04017001, 2017.
[19] Alain B Giorla and Cyrille F Dunant. Microstructural effects in the simulation of creep of concrete. Cement and Concrete Research, 105:44{53, 2018.
[20] Cyrille F Dunant and Karen L Scrivener. Physically based models to study the alkali-silica reaction. Proceedings of the Institution of Civil Engineers-Construction Materials, 169(3): 136{144, 2016.
[21] Cyrille Dunant. Experimental and modelling study of the alkali-silica-reaction in concrete. PhD thesis, 2009.
[22] HAROLD R Kokal and MADHU G Ranade. Metallurgical uses-fluxes for metallurgy. Ind. Miner. Rocks, 15:661{675, 1994.
[23] P Kumar Mehta and PJM Monteiro. Concrete: structures, properties and materials. Sao Paulo: IBRACON, 2008.
[24] John Espen Rossen. Composition and morphology of cash in pastes of alite and cement blended with supplementary cementitious materials. Technical report, EPFL, 2014.
[25] Alessandra Primavera, Laura Pontoni, Davide Mombelli, Silvia Barella, and Carlo Mapelli. Eaf slag treatment for inert materials' production. Journal of Sustainable Metallurgy, 2(1):3-12, 2016.
[26] D Kulik, U Berner, and E Curti. Modelling chemical equilibrium partitioning with the gems-psi code. Technical report, 2004.
[27] Pawe I T Durdzinski, Cyrille F Dunant, Mohsen Ben Haha, and Karen L Scrivener. A new quantification method based on sem-eds to assess fly ash composition and study the reaction of its individual components in hydrating cement paste. Cement and Concrete Research, 73:111{122, 2015.
[28] Jose Granja and Miguel Azenha. Towards a robust and versatile method for monitoring e-modulus of concrete since casting: Enhancements and extensions of emm-arm. Strain, 53(4):e12232, 2017.
[29] Robert A. Bullard, EFFECT OF COOLING RATES ON MINERALIZATION IN PORTLAND CEMENT CLINKER, University of Missouri-Kansas City, 2015, https://core.ac.uk/download/pdf/62782661.pdf

1. A process for the combined manufacture of steel and cement clinker, the process including the steps:
providing an electric arc furnace;
providing steel scrap;
providing cement paste derived from construction and demolition waste;
loading the steel scrap in the electric arc furnace for forming molten steel;
loading the cement paste in the electric arc furnace to act as a flux for the steel to assist in the removal of impurities from the molten steel and forming an electric arc furnace slag, wherein the heat of the molten steel promotes clinkering of the electric arc furnace slag to form clinkered electric arc furnace slag; and
removing the clinkered electric arc furnace slag from the electric arc furnace.

2. The process according to claim 1 wherein the maximum operating temperature experienced by the clinkered electric arc furnace slag in the electric arc furnace is at least 1500° C.

3. The process according to claim 1 wherein the clinkered electric arc furnace slag, on removal from the electric arc furnace, is cooled from the operating temperature of the electric arc furnace and the cooling rate of the clinkered electric arc furnace slag is such that the temperature of the clinkered electric arc furnace slag cools from the operating temperature of the electric arc furnace to 950° C. or below in a time of 20 minutes or less.

4. The process according to claim 1 wherein the cement paste added to the electric arc furnace is pelletised before being added to the electric arc furnace.

5. The process according to claim 1 wherein the cement paste is combined with one or more additional materials to assist with fluxing of the steel.

6. The process according to claim 5 wherein the additional material is or includes CaO.

7. The process according to claim 5 wherein the ratio of cement paste to additional material is in the range defined by 75 wt % cement paste: 25 wt % additional material at one limit to 99 wt % cement paste: 1 wt % additional material at the other limit.

8. The process according to any one of claim 1 wherein the clinkered electric arc furnace slag is Portland cement clinker.

9. The process according to claim 1 wherein the clinkered electric arc furnace slag is a hydraulic material consisting of at least two-thirds by mass of calcium silicates, the ratio of CaO to SiO2 is not less than 2.0 and the magnesium oxide content does not exceed 5.0% by mass.

10. The process according to claim 9 wherein the calcium silicates are Alite, Belite, or a combination of Alite and Belite.

11. Cement clinker obtained as a product of a process of combined manufacture of steel and cement clinker, the process including the steps:
providing an electric arc furnace;
providing steel scrap;
providing cement paste derived from construction and demolition waste;
loading the steel scrap in an electric arc furnace for forming molten steel;
loading the cement paste in the electric arc furnace to act as a flux for the steel to assist in the removal of impurities from the molten steel and forming an electric arc furnace slag, wherein the heat of the molten steel promotes clinkering of the electric arc furnace slag to form clinkered electric arc furnace slag; and
removing the clinkered electric arc furnace slag from the electric arc furnace.

12. Cement obtained by or obtainable by grinding the cement clinker of claim 11 and adding gypsum.

13. Cement according to claim 12 which is CEM I cement.
